(19) United States
(12) Patent Application Publication
(10) Pub. No.: US 2009/0239083 A1
(43) Pub. Date: Sep. 24, 2009

(54) PAINT FOR PREVENTING SURFACE REFLECTION

(75) Inventors: Tatsuya Kojima, Tokyo (JP); Takuro Okubo, Tokyo (JP); Takashi Takahashi, Tokyo (JP)

Correspondence Address: FOLEY AND LARDNER LLP;SUITE 500, 3000 K STREET NW, WASHINGTON, DC, 20007, US

(73) Assignee: KABUSHIKI KAISHA TOPCON

(21) Appl. No.: 12/404,732

(22) Filed: Mar. 16, 2009

(30) Foreign Application Priority Data
Mar. 19, 2008 (JP) 2008-071732
Jan. 6, 2009 (JP) 2009-000904

(51) Int. Cl. B32B 27/30; B32B 27/32; B32B 27/40; C09D 113/00; C09D 161/28

(52) U.S. Cl. 428/422.8; 428/411.1; 428/500; 524/556; 524/597; 524/549

(57) ABSTRACT

The surface reflection is prevented by application of a black paint to an element such as a unit or parts forming an optical system, in particular an inner face of a camera lens tube portion and the end face portion of a lens, or the like. Application of the black paint to the element leads to the formation of a black coating film of from 0.35% to 0.7% that is an extremely low reflectance onto a surface of the element in a wide-ranging wavelength region from 380 nm to 780 nm, regardless of the material thereof.

### FIELD OF THE INVENTION

The present invention relates to a paint for preventing reflections from a surface of an element such as a camera lens unit and parts, and a method of preventing their surface reflections, and particularly relates to use of a paint for preventing surface reflections of such an element.

### RELATED ART

In general, cameras are usually subjected to antireflection treatment applied to their inner wall surfaces, because incident light from lenses reflected at the inner wall surfaces exposes a film during photographing to generate halations or ghosts, or because light from a light source reflects at the camera inner wall surfaces to inject into the finder light path and thereby to cause the field of view image of the finder to be difficult to see in some cases.

A technique is conventionally known as a antireflection treatment that includes immersing the surface of the inner wall of a lens barrel, for example, in a solution of a fluorocarbon resin (e.g., the transparent fluorocarbon resin “CYTOP” (registered trademark, Asahi Glass Co., Ltd.; low refractive index: 1.34)) or depositing, for example, MgF2 (refractive index: 1.38) on the surface by a vacuum deposition method to form and set an antireflection film as a thin film of an optimal film thickness, and setting the refractive index of the antireflection film at a value lower than the refractive index of a resin material such as black polycarbonate (refractive index: 1.58), a black Noryl resin or black ABS resin, making up the lens barrel, or applying black alumite processing or black acrylic resin coating to the inner wall surface when the lens barrel is made up of a metal member such as AL. Refer to Japanese Patent Laid-Open No. H05-341167.

In addition, paper, synthetic paper, synthetic resin films and the like are used, for example, for antireflection films to be stuck to flexible printed circuit boards and the inner face walls of cameras as their substrates. Films of polyolefins, polyesters, polyimides, and the like can be used as synthetic resin films. Black pigments like carbon black and aniline black are kneaded to these films in advance. Refer to Japanese Patent No. 3934199.

Additionally, a black pigment, which blackens a paint, causes a light absorbing film formed by applying the resulting paint to finally exhibit light absorptivity. For example, iron black, carbon black, titanium black, and the like can be used for black pigments. From the viewpoint of sufficient light absorptivity being obtained as a light absorbing film, namely, the reflection density as the light absorbing film being 1.60 or more, preferably 1.65 or more, more preferably 1.70 or more, such a black pigment is mixed in a ratio of 5 parts by weight or more, preferably 6 parts by weight or more, more preferably 7 parts by weight or more, based on 100 parts by weight of the binder resin. An organic solvent having a relatively high evaporation rate is preferably used as a solvent. The examples that can be used include ketones such as methyl ethyl ketone, methyl isobutyl ketone and cyclohexanone, esters such as methyl acetate, ethyl acetate and butyl acetate, ethers such as methyl cellosolve and ethyl cellosolve, alcohols such as methyl alcohol, ethyl alcohol and isopropyl alcohol, and the like. The substrate is permissible so long as it is thin and excellent in flexibility and is not especially inherently limited. The examples that can be used include paper, synthetic paper, plastic films, and the like. From the viewpoint of suppressing the generation of wastes as much as possible, a variety of plastics such as polyethylene terephthalate, polycarbonate, polypropylene, polyethylene, polyvinyl chloride, polyethylene naphthalate and polystyrene are suitably used. In particular, blackened plastics are known to be more suitably used. Refer to Japanese Patent No. 4002453.

Moreover, a mirror body of a camera is known that is formed with fluorine-containing polycarbonate, in which the inside is black coated, black processed and stuck with a black tape, the motor surface is roughened, processing is performed in combination of these for a low light reflection, and the whole or the outer periphery of the casing is made up of a low light reflectance material, resulting in a low light reflectance. Refer to Japanese Patent Laid-Open No. 2006-145927.

Current black paints pose problems in that sufficient adhesion properties are not obtained depending on materials of substrates to thereby have a possibility of causing peeling.

### SUMMARY OF THE INVENTION

It is an object of the present invention to provide a paint that can control the reflectance to be 1% or less, independently of the material of the substrate, without needing primer processing and the like, by forming a black coating film that is good in adhesion properties and generate no scrapings, and use of a paint for preventing surface reflections.

According to the present invention, a paint is a black paint which contains a resin as a base and a carbon black as an additive. Such a paint is provided on a surface of an element so that a uniform black coating film can be formed, independently of the material of the element as a coating target, and is good in adhesion properties for all materials and generates no scrapings.

In addition, blackening can be excellently treated and the antireflection efficiency can be improved by a factor of 2 or more as compared with the conventional antireflection efficiency.

In a preferred embodiment of the present invention, examples of the elements are a unit and parts forming an optical system, such as lens tube inner faces for camera lenses and lens end face portions of a digital camera, a video, a zoom optical system for mobile phones, optical pickups of a DVD®, an HDDVD® and a Blue-Ray® recorder and the like.

The present invention includes use of a paint such as a black paint for preventing surface reflection by applying the black paint to an element surface such as the inner face of a camera lens tube portion and a lens end face portion, wherein a black coating film exhibiting an extremely low reflectance of from 0.35% to 0.7% is formed in a wide-ranging wavelength region of from 380 nm to 780 mm.

Additionally, a preferred base of a black paint is an acrylic resin and wherein carbon black is added as an additive.

Moreover, another preferred base of a black paint is a modified vinyl acetate resin and wherein carbon black is added as an additive.

Furthermore, another proffered base of a black paint is a specific alkyd-melamine resin and wherein carbon black is added as an additive.

In addition, another proffered base of a black paint is a maleic anhydride acrylic modified polyolefin resin and wherein carbon black is added as an additive.

In a more preferred embodiment of the present invention, upon blackening of a unit and parts forming an optical system, such as the inner face of a camera lens tube and a lens end face portion, resins as bases of paints, additives and the method of application are in the following.

(a) The resins as bases of paints are as follows.

Acrylic resins, urethane resins, melamine resins, polyester resins, polypropylene resins, alkyd resins, epoxy resins, acrylic urethane resins, specific alkyd-melamine resins, silicone resins, modified vinyl acetate resins, maleic anhydride acrylic modified polyolefin resins, maleic anhydride modified chlorinated polypropylene resins, and the like.

(b) The additives can include the following.

In addition to VALIFAST BLACK series, OIL BLACK series, BONJET BLACK CW-2 and MICROPIGMO WMBK-5 available from Orient Chemical Industries, Ltd. and NEOZAPON BLACK available from Basf Japan Ltd., carbon black, water-containing silicon oxide, a variety of organic solvents including a hydrocarbon system such as ethyl acetate, butyl acetate, ethyl benzene, trimethyl benzene, mineral spirit, methylcyclohexane, cyclohexane, methyl ethyl ketone, xylene, toluene, cyclohexane, methyl isobutyl ketone, diacetone alcohol, ethylene glycol monomethyl ether and ethylene glycol monobutyl ether, cyclo-olefin based compounds, an alcohol system, an acetone system, a ketone system, and an ester system.

(c) In addition, the present invention preferably uses a dip coating method as a method of application of blackening. However, the present invention is not limited thereto and its examples may include a dipping method, a spin coating method, a bar coating method (a solution coating method) and a vacuum deposition method.

### BRIEF DESCRIPTION OF THE DRAWINGS

FIG. 1 shows a graph indicating that a black coating film used in the present invention exhibits a low reflectance in a wide-ranging wavelength region. The abscissa takes a wavelength (nm) and the ordinate takes a reflectance (%).

### DESCRIPTION OF EMBODIMENTS

A black coating film formed with a black paint prepared by a combination of a resin and an additive described in (a) to (c) above improves the antireflection efficiency by a factor of 2 or more as compared with a conventional coating film.

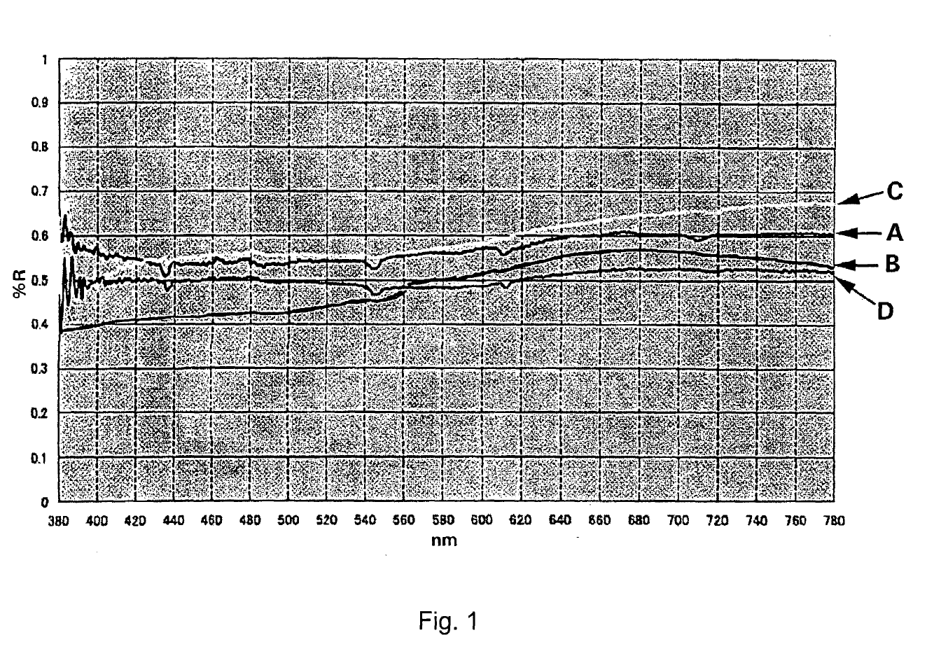

For example, when the surface reflectance of a material that is able to be made by these combinations was measured, the measured data results are shown in FIG. 1.

Here, the combinations of A, B, C and D of FIG. 1 are as follows.

A: The resins that are bases of paints include acrylic resins, and the like.

The additives include the VALIFAST BLACK series and carbon black available from Orient Chemical Industries, Ltd.

B: The resins include modified vinyl acetate resins and the like.

The additives include BONJET BLACK CW-2 and carbon black.

C: The resins include specific alkyd-melamine resins, and the like.

The additives include NEOZAPON BLACK and carbon black available from Basf Japan Ltd.

D: The resins include maleic anhydride acrylic modified polyolefin resins and the like.

The additives include OIL BLACK series and carbon black available from Orient Chemical Industries, Ltd.

FIG. 1 shows that any of the black coating films of A to D exhibit extremely low reflectances of from 0.35% to 0.7% in a wide-ranging wavelength region of from 380 nm to 780 nm.

A resin that is a base of a paint listed above is combined with an additive in a constant mixing ratio (e.g., resin: 90 to 95%, additive: 5 to 10%) to prepare a black paint. This paint is applied to units and each parts forming an optical system such as a lens tube and a lens end face of a digital camera, a video, a zoom optical system for mobile phones, optical pickups of a DVD®, an HDDVD® and a Blue-Ray® recorder and the like. This makes it possible to carry out excellent blackening. This black paint can improve the antireflection efficiency by a factor of 2 or more as compared with conventional paints, thereby having an inherent optical performance. This black paint can avoid optional flare and ghost. This black paint can be applied to plastic lens or the like. Also, this black paint can be provided on an inner and/or outer surface of various elements such as a casing of TV, desk-top type or note type personal computers, portable telephone, video recorders, and others.

### Example 1

A black paint is prepared by mixing an additive in a ratio of 5 parts by weight or more, preferably 6 parts by weight or more, more preferably 7 parts by weight or more, with a solution, in a ratio of 100 parts by weight, having dissolved therein an acrylic resin that is a base and agitating. A dip coating method is preferably used as a method of applying a black paint. However, the method is not limited thereto and its examples that are good include wet methods such as a dipping method, a spin coating method and a bar coating method (solution coating methods) and a brush painting method.

### Example 2

A black paint is prepared by mixing an additive in a ratio of 5 parts by weight or more, preferably 6 parts by weight or more, more preferably 7 parts by weight or more, with a solution, in a ratio of 100 parts by weight, having dissolved therein a modified vinyl acetate resin that is a base and agitating. A dip coating method is preferably used as a method of applying a black paint. However, the method is not limited thereto and its examples that are good include wet methods (solution coating methods) such as a dipping method, a spin coating method and a bar coating method and a brush painting method.

### Example 3

A black paint is prepared by mixing an additive in a ratio of 5 parts by weight or more, preferably 6 parts by weight or more, more preferably 7 parts by weight or more, with a solution, in a ratio of 100 parts by weight, having dissolved therein a specific alkyd-melamine resin that is a base and agitating. A dip coating method is preferably used as a method of applying a black paint. However, the method is not limited thereto and its examples that are good include wet methods (solution coating methods) such as a dipping method, a spin coating method and a bar coating method and a brush painting method.

### Example 4

A black paint is prepared by mixing an additive in a ratio of 5 parts by weight or more, preferably 6 parts by weight or more, more preferably 7 parts by weight or more, with a solution, in ratio of 100 parts by weight, having dissolved therein a maleic anhydride acrylic modified polyolefin resin that is a base and agitating. A dip coating method is preferably used as a method of applying a black paint. However, the method is not limited thereto and its examples that are good include wet methods (solution coating methods) such as a dipping method, a spin coating method and a bar coating method and a brush painting method.

1. A method of antireflection treatment for preventing surface reflection, comprising applying a black paint to a surface of an element, wherein
a black coating film exhibiting an extremely low reflectance of from 0.35% to 0.7% is formed in a wide-ranging wavelength region of from 380 nm to 780 nm, by applying the black paint to the surface of the element, regardless of materials thereof.

2. The method according to claim 1, wherein
a base of the black paint is an acrylic resin, and wherein carbon black is added as an additive.

3. The method according to claim 1, wherein
a base of the black paint is a modified vinyl acetate resin, and wherein carbon black is added as an additive.

4. The method according to claim 1, wherein
a base of a black paint is a specific alkyd-melamine resin, and wherein
carbon black is added as an additive.

5. The method according to claim 1, wherein
a base of a black paint is a maleic anhydride acrylic modified polyolefin resin and wherein
carbon black is added as an additive.

6. Use of a black paint for preventing surface reflection.

7. The use as defined in claim 6, wherein the black paint is provided on a surface of an element so that a black coating film exhibiting an extremely low reflectance of from 0.35% to 0.7% is formed on the surface of the element, in a wide-ranging wavelength region of from 380 nm to 780 nm, regardless of materials thereof.

8. The use according to claim 6, wherein
a base of the black paint is an acrylic resin and wherein carbon black is added as an additive.

9. The use according to claim 6, wherein
a base of a black paint is a modified vinyl acetate resin and wherein carbon black is added as an additive.

10. The use according to claim 6, wherein
a base of a black paint is a specific alkyd-melamine resin and wherein carbon black is added as an additive.

11. The use according to claim 6, wherein
a base of a black paint is a maleic anhydride acrylic modified polyolefin resin and wherein carbon black is added as an additive.
